(19) United States
(12) Patent Application Publication
(10) Pub. No.: US 2015/0093509 A1
(43) Pub. Date: Apr. 2, 2015

(54) SUBSTRATE STAIN COMPOSITIONS AND METHODS OF APPLICATION

(71) Applicant: PureColor, Inc., Albuquerque, NM (US)

(72) Inventors: Edward A. Kennedy, Santa Fe, NM (US); Charles J. Villanueva, Albuquerque, NM (US); William Mark Miles, Tijeras, NM (US); Kano Jessica Garrett, Santa Fe, NM (US); Michelle A. Bilder, Irvine, CA (US)

(21) Appl. No.: 14/504,010

(22) Filed: Oct. 1, 2014

Related U.S. Application Data
(60) Provisional application No. 61/885,414, filed on Oct. 1, 2013.
(60) Provisional application No. 61/901,722, filed on Nov. 8, 2013.

(51) Int. Cl. C09D 5/29; B65D 81/32; B44F 9/02; B05D 1/02; B05D 5/06

(52) U.S. Cl. CPC C09D 5/29; B05D 1/02; B05D 5/065; B44F 9/02; B65D 81/3205
USPC 427/280; 206/568; 106/34; 524/1

(57) ABSTRACT

Compositions and methods for changing the color of non-wood substrates. A one step method uses a solution of a water soluble pigment or dye and a metal salt. The non-toxic solution can be sprayed on a primed or unprimed substrate without wiping. The method can produce an even color on a smooth substrate, or a simulated woodgrain pattern or color on a textured substrate. The composition and method can be used on substrates as varied as fiberboard, fiberglass, steel, vinyl, plastics, metals, concrete, brick, stone, and stucco. The composition can include a resin which is emulsified when added and subsequently demulsifies. A two step method includes the additional step of applying a gall ink to the substrate. The compositions can be distributed as kits containing multiple packages of dry or concentrated ingredients, which make the final composition(s) when hydrated. Simply changing one of the packages can change the composition's application method, application effect, or intended substrate, thus enabling the creation of a system with simplified inventory and shipping requirements.

### CROSS-REFERENCE TO RELATED APPLICATIONS

This application claims priority to and the benefit of the filing of U.S. Provisional Patent Application Ser. No. 61/885,414, filed on Oct. 1, 2013, entitled “Substrate Stain Compositions And Methods Of Application” and U.S. Provisional Patent Application Ser. No. 61/901,722, filed on Nov. 8, 2013, also entitled “Substrate Stain Compositions And Methods Of Application”, the specification and claims of which are incorporated herein by reference.

### BACKGROUND OF THE INVENTION

1. Field Of The Invention (Technical Field)

This invention relates to water-based stains and colorants for smooth and/or textured substrates, preferably non-wood substrates.

2. Background Art

Note that the following discussion refers to a number of publications and references. Discussion of such publications herein is given for more complete background of the scientific principles and is not to be construed as an admission that such publications are prior art for patentability determination purposes.

U.S. Patent Publication No. 2010/0310826 describes a process to achieve a wood-grained like appearance on wood simulated textured panels. To do this process, the user must first apply a basecoat to the substrate, followed by the application of a glaze. Once the glaze has dried, the user wipes, sponges or brushes off the surface peaks of the wood-grain textured substrate, leaving contrast of color in the recess of the wood-grain textured substrate; i.e. leaving the recesses darker in color, providing the wood-grained like appearance. This laborious multi-step process demonstrates inefficiencies in material use and labor cost, because the user must wipe, brush or sponge off the excess glaze. Also, there is a considerable process time, as three steps must be applied and dried before a protective clear topcoat can be applied resulting in a finished product. Other coatings that impart a wood-like appearance, such as described in U.S. Pat. No. 5,334,633, comprise hazardous and/or environmentally damaging ingredients.

### SUMMARY OF THE INVENTION (DISCLOSURE OF THE INVENTION)

The present invention is a composition for changing a color of a primed or unprimed non-wood substrate, the composition comprising at least one water soluble pigment and/or dye, a mineral salt, and water. The composition preferably comprises substantially no volatile organic compounds, hazardous air pollutants, or organic solvents and is preferably formulated to be a one step composition that is preferably applied using only spraying. The composition is preferably formulated to produce a simulated woodgrain colored pattern or finish on a textured non-wood substrate in one step. The composition preferably further comprises a substance selected from the group consisting of ionic substance, amino acid, binder, UV inhibitor, surfactant, biopolymer, polymer saccharide, poycationic polymer, polyquaternium, carbohydrate, and gum, which substance preferably alters the surface tension, viscosity, electrostatic properties, or shear thinning properties of the composition. The concentration of the water soluble pigment and/or dye is preferably between approximately 0.5% and 50% by weight, and more preferably between approximately 1% and 20% by weight. The concentration of the mineral salt is preferably between approximately 0.05% and 30% by weight, and more preferably between approximately 0.1% and 20% by weight. The composition preferably further comprises a resin, preferably having a concentration between approximately 0.5% and 20% by weight, and more preferably between approximately 1% and 10% by weight. The resin preferably demulsifies in the composition sufficiently for the composition to comprise a heterogeneous two phase mixture.

The present invention is also a method for changing the color of a primed or unprimed non-wood substrate, the method consisting essentially of applying the composition of claim 1 to a primed or unprimed non-wood substrate; and subsequently coating the colored substrate with a protective coat. The composition was preferably previously created by hydrating dry and/or concentrated ingredients. The applying step preferably consists essentially of spraying, and the method preferably results in a simulated woodgrain colored pattern or finish on a textured non-wood substrate.

The present invention is also a method for changing the color of a primed or unprimed non-wood substrate, the method consisting essentially of applying a gall ink to the substrate, applying the composition of claim 1 to the substrate, and subsequently coating the colored substrate with a protective coat. The ratio of the amount of metal salt to the amount of tannin or tannic acid in the gall ink is preferably approximately 1:5, and more preferably approximately 1:1.3. Either or both of the applying steps preferably consist essentially of spraying. The method preferably results in a simulated woodgrain colored pattern or finish on a textured non-wood substrate.

The present invention is also a kit comprising a first container containing a first concentrate comprising a pigment and/or dye, and a second container containing dry or concentrated mineral salts; wherein adding a specified amount of water to a mixture of contents of said containers produces a specified amount of the composition of claim 1. The kit preferably further comprises a container containing a second concentrate comprising a resin and/or a container containing dry or concentrated gall ink components. The second concentrate preferably further comprises one or more substances selected from the group consisting of pigment, water, amino acid, surfactant, and emulsifying agent. Preferably replacing only the second container with a different container enables said composition to be applied on a different substrate, applied with a different application method, and/or to produce a different effect, said second container containing first mineral salts and said different container containing second mineral salts.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate embodiments of the present invention and, together with the description, serve to explain principles of the invention. The drawings are only for the purpose of illustrating certain embodiments of the present invention and are not to be construed as limiting the invention. In the drawings:

FIG. 1 shows a kit in accordance with an embodiment of the present invention.

FIG. 2 shows a kit in accordance with another embodiment of the present invention.

### DETAILED DESCRIPTION OF EMBODIMENTS OF THE INVENTION

Embodiments of the present invention relate to compositions and processes for creating a color stain on smooth, preferably non-wood substrates and/or a wood-grain contrast on textured non-wood substrates. A large variety of smooth or textured non-wood substrates can be used, including but not limited to hardboard, primed substrates, base coated substrates, sheet molded compounds (SMC), steel, smooth and textured vinyl, composites, resins, plastics, medium density fiberboard (MDF), paper products, foil, and metals. Embodiments of the present invention produce a realistic wood-grained appearance on textured, non-wood substrates and/or color smooth non-wood substrates, such as molded hardboard doors or SMC doors. In some embodiments of the present invention, no hand wiping is necessary; application of the composition can be accomplished solely by spraying.

Embodiments of the process of the present invention utilize either a one step or two step system to achieve a realistic wood-grain like appearance on a textured, non-wood substrate. The application means may comprise brushing, wiping, sponging, spraying or any other application means. Compositions of the present invention preferably comprise little to no volatile organic compounds (VOCs), hazardous air pollutants (HAPS) or organic solvents, and are preferably water-based and non-toxic. As used throughout the specification and claims, the term “one step” means requiring only one application step to impart a color contrast or change to a primed or unprimed substrate prior to, and without substantial influence from, the application of a protective coat such as a clear coat or topcoat. As used throughout the specification and claims, the term “two step” or “two steps” means requiring only two application steps to impart a color contrast or change to a primed or unprimed substrate prior to, and without substantial influence from, the application of a protective coat such as a clear coat or topcoat.

Embodiments of the present invention comprise compositions and methods for treating non-wood substrates, and more specifically for imparting a change to a characteristic of a non-wood substrate. The composition is preferably a stain or a colorant. Embodiments of the present invention comprise a composition called the colorant/salt solution for use with a one step application process, the solution preferably comprising a solution of water dispersible pigments and/or dyes and a mineral salt. The concentration of pigment and/or dye in the composition is preferably from approximately 0.1% to 90% by weight, more preferably from approximately 0.5% to 50% by weight, and even more preferably from approximately 1.0% to 20% by weight. Any water dispersible pigment and/or dye can be used, including but not limited to the Aurasperse II line of pigments manufactured by BASF and the Colortrend line manufactured by Chromeflo Technologies. The concentration of the mineral salt(s) is preferably from approximately 0.01% to 50% by weight, more preferably from approximately 0.05% to 30% by weight, and even more preferably from approximately 0.1% to 20% by weight. Any mineral salt can be used, including but not limited to silver nitrate, magnesium chloride, sodium percarbonate, sodium carbonate, sodium chloride, calcium carbonate, iron sulfate, manganese sulfate, sodium silicate, sodium sulfate, sodium bicarbonate, sodium perborate, copper chloride, copper acetate, and mixtures thereof. One or more other ionic substances, such as amino acids, may alternatively be used, either alone or in combination with one or more mineral salts. The composition may optionally comprise other compounds to increase the performance and/or stability of the invention, such as a binder to increase adhesion to the substrate and/or a UV inhibitor to increase light fastness. The ingredients used in the composition are preferably formulated and combined with one another in accordance with methods known in the art.

In some embodiments a resin is added to the solution of water dispersible pigments and/or dyes and a mineral salt. It is preferable that the resin is emulsified or dispersed before it is added. The concentration of the resin in the composition is preferably approximately 0.1% to 50% by weight, more preferably from approximately 0.5% to 20% by weight and even more preferably approximately 1% to 10% by weight. When the colorant/salt solution is mixed with the emulsified resin, the emulsified resin preferably demulsifies sufficiently in order to create a heterogeneous mixture, with one phase being the colorant/salt and the other being the demulsified resin. The demulsified resin has greater density than the colorant/salt solution, so it sinks to the bottom of the solution. It is believed that the reaction between colorant/salt solution and emulsified resin drives the desired contrast in the wood grain textures. Upon application onto a textured substrate, the denser demulsified resin will flow more readily into the recesses in the texture, creating a denser color within the recesses, imparting the contrast. Inclusion of such a resin enables the use of noncorrosive, non-hazardous mineral salts, instead of sodium hydroxide, sodium percarbonate, or sodium metasilicate.

Other embodiments of the present invention comprise an additional composition for use with a two step application process. The additional composition preferably comprises a stabilized solution of metal salts and tannins or tannic acid, commonly known as gall inks. The ratio of metal salts to tannins or tannic acid in the gall ink is preferably approximately 1:10, more preferably approximately 1:5, and even more preferably approximately 1:1.3. Other compounds may optionally be added to the composition to increase the performance and/of stability of the invention such as, but not limited to, antioxidants, weak acids, weak bases, chelates, and the like. The second composition for use with the two step process preferably comprises the colorant/salt solution described above for a one step application process.

The substrate preferably comprises a non-wood material that is either textured with a wood-grain texture or comprises a smooth surface. Example substrates include, but are not limited to, hardboard, high-density fiberboard (HDF), sheet molded compound (SMC), medium density fiberboard (MDF), fiberglass, primers, a primed substrate, steel, vinyl, plastics, metals, concrete, brick, stone, paper products, stucco and the like.

The method for producing the change in the substrate, preferably a change in the color of the substrate, preferably comprises either a one step application of an embodiment of the colorant/salt solution of the present invention, or a two step application both of an embodiment of the gall ink and an embodiment of the colorant/salt solution. In the two step process, the gall ink is preferably applied to the substrate first and preferably dried, followed by the application of the mineral salt and pigment and/or dye solution, thereby generating the change in the substrate. The compositions can be applied in any order and/or by any application method, including but not limited to spray, brush, sponge or through automate appliers such a roll-coater, reciprocating spray system, fan coaters, vacuum coaters and the like. Once the composition(s) have dried, a lasting color or stain will be imparted on the substrate. On wood-grain textured substrates, such as molded hardboard doors, the color will preferably be darker in the recesses of the texture, with the peaks being lighter in color, providing a contrast in the grain pattern giving the appearance of real wood. The opposite effect (that is the color being lighter in the recesses) is possible to obtain depending on which mineral salts are used in the colorant/salt solution. On smooth surfaces, a uniform lasting color that conforms to the topography of the substrate will preferably be imparted. The colors used in the colorant/salt solution are preferably selected to match the look of natural or stained wood varieties, such as cherry, alder, maple, and the like. The pigments and/or dyes used can be those that are typically used in similar compositions.

In an alternative embodiment of the invention, the mineral salt can be supplemented or replaced with one or more supplemental additives such as surfactants, biopolymers, polymers saccharides, carbohydrates, gums, natural gums, and the like. The supplemental additives optionally modify one or more fluid mechanical properties of the composition, such as surface tension, viscosity, shear thinning, and the like. For example, on a non-textured primed HDF door or door skin, the mineral salt used can be supplemented with a polycationic polymer, such as a polyquaternium, to increase the viscosity of the composition. When such composition is applied, the resulting stain has an increased color density as compared to when the composition does not comprise such a supplemental additive. Likewise, the mineral salt can be supplemented with a surfactant in order to adjust the surface tension of the composition so that it can flow over a specific substrate such as fiberglass.

Following the application, any protective water-based topcoat or solvent-based topcoat may be applied depending on the application and requirements for the substrate. An example of a commercially available topcoat is PureColor, Inc.'s PureShield polyurethane dispersion.

The inclusion of the mineral salts in the colorant/salt solution, acting in concert with the pigments and/or dyes, may provide modification to the surface tension and electrostatics of the composition that enable it to impart a desired stain effect. For example, on wood-grain textured hardboard doors, the surface tension is preferably modified so that the composition is able to flow into the recesses of the texture more readily, thereby enhancing the contrast in color on a simulated wood-grain pattern. The reaction of the salts, pigments, and resin preferably generate the contrast. Similarly, on smooth sheet molded compound (SMC) doors, the surface tension and electrostatics can be modified using a separate formula of mineral salts and pigments and/or dyes to provide an evenly colored stain that conforms to the topography of the substrate. The formula can be modified by using any other additives that can modify the surface tension and electrostatics of the composition in order to produce or match any desired effect on any substrate. Similarly, although gall ink is preferably used (preferably in the first application step of the two step process), any other ink, dye or pigment that can be modified so that the resulting surface tension produces a desired effect, such as enabling contrast in the grain pattern, can be used.

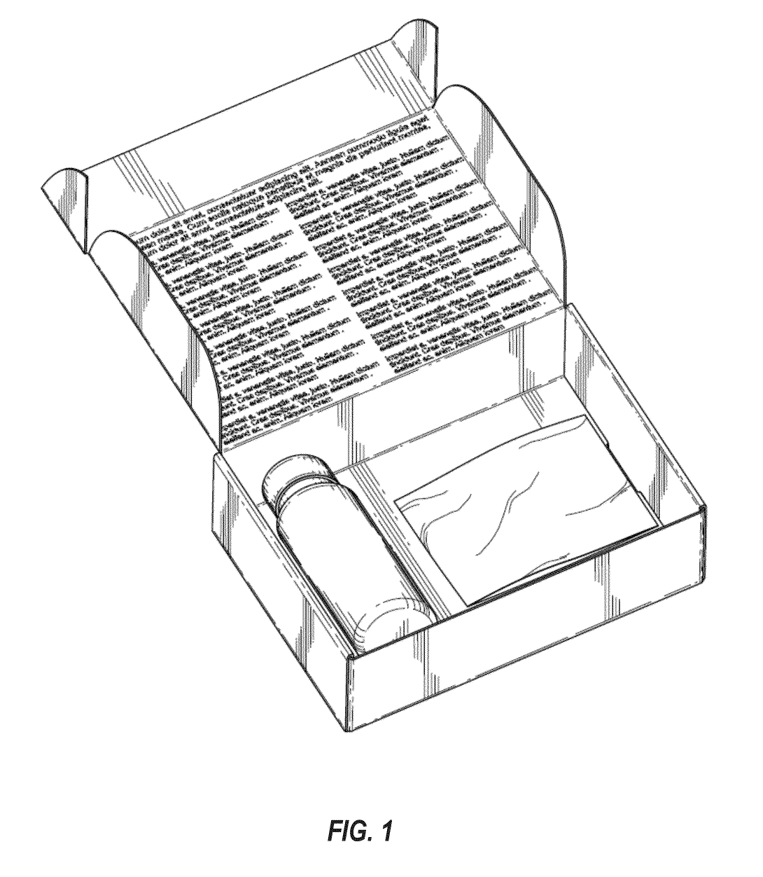

A kit for one step applications according to the invention may optionally be distributed in two small packages that can preferably be hydrated and diluted on-site, one package containing the mineral salts and one containing the water dispersible pigments and/or dyes, as shown in FIG. 1. A third package containing the emulsified or dispersed resin is not shown. For two step applications, the kit preferably comprises a fourth package (not shown) containing the dry gall ink components, which also can be hydrated and diluted on-site, instead of or in addition to the emulsified or dispersed resin. An optional package of additives, such as the aforementioned binders, may also be included. The packages are preferably distributed in a single box, which has advantages that are distinctly different than the prior art methods. Shipping costs are drastically reduced as compared to the prior art due to the reduced size and weight of the package. The box contains no hazardous chemicals, so it can be shipped overnight via a carrier, enabling a just-in-time distribution model. Inventory space required to store the product is also reduced to a fraction of what it would be using the prior art methods, reducing overhead, facilities costs and indirect costs. Instructions may optionally be included in the box or printed on any surface of the box, including but not limited to the inside top cover or the bottom of the box. The kit is preferably hydrated and diluted on-site to form the final composition of the present invention. The pigments and/or dyes as well as the mineral salts are preferably to be mixed with the required amount of water. The pigments and/or dyes may be added to the water before or after the mineral salts. The gall ink components are preferably to be mixed with the required amount of water as well. The kit can vary in size depending on the requirements of the user; for example, kits may be sold that make 1 gallon, 5 gallons, or 55 gallons of either or both compositions.

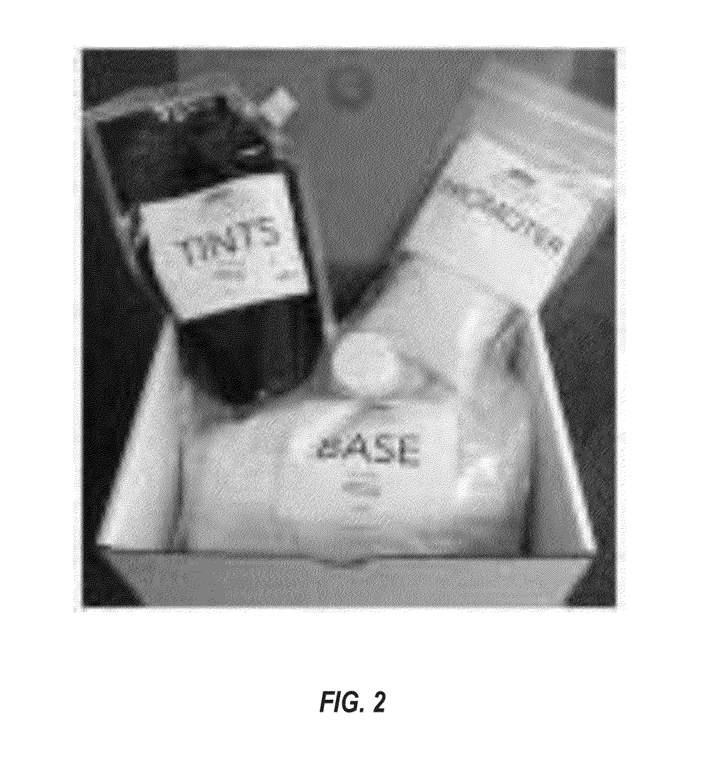

Another embodiment of a kit in accordance with the present invention is shown in FIG. 2. The kit comprises a first container, for example a bag such as a box wine bag, containing a base concentrate comprising one or more of an emulsified or dispersed resin, drywall primer or other tint, water, and an amino acid such as glycine. A second package contains a preferably liquid tint concentrate comprising a pigment and one or more optional dispersants and/or stabilizers. A third additive or promoter package comprises dry mineral salts. Mixing all of the ingredients in the packages together with water in a specified amount produces a predetermined amount of the colorant/salt solution. An advantage of this embodiment is that it enables the creation of a colorant system comprising an easily manufacturable and inventoried product platform. By simply including different third packages in the kit, different results or applications may be obtained. For example, one of the third packages might enable a translucent effect; another could enable use of the composition on a different substrate such as concrete or a primed substrate, and still another could be designed to be applied using a different application method.

Although the invention has been described in detail with particular reference to the disclosed embodiments, other embodiments can achieve the same results. Variations and modifications of the present invention will be obvious to those skilled in the art and it is intended to cover all such modifications and equivalents. The entire disclosures of all patents and publications cited above are hereby incorporated by reference.

What is claimed is:

1. A composition for changing a color of a primed or unprimed non-wood substrate, the composition comprising:
at least one water soluble pigment and/or dye;
a mineral salt; and
water.

2. The composition of claim 1 comprising substantially no volatile organic compounds, hazardous air pollutants, or organic solvents.

3. The composition of claim 1 formulated to be a one step composition.

4. The composition of claim 3 formulated to be applied using only spraying.

5. The composition of claim 1 formulated to produce a simulated woodgrain colored pattern on a textured non-wood substrate in one step.

6. The composition of claim 1 further comprising a substance selected from the group consisting of ionic substance, amino acid, binder, UV inhibitor, surfactant, biopolymer, polymer saccharide, poycationic polymer, polyquaternium, carbohydrate, and gum.

7. The composition of claim 6 wherein said substance alters the surface tension, viscosity, electrostatic properties, or shear thinning properties of the composition.

8. The composition of claim 1 wherein a concentration of said water soluble pigment and/or dye is between approximately 0.5% and 50% by weight.

9. The composition of claim 8 wherein a concentration of said water soluble pigment and/or dye is between approximately 1% and 20% by weight.

10. The composition of claim 1 wherein a concentration of said mineral salt is between approximately 0.05% and 30% by weight.

11. The composition of claim 10 wherein a concentration of said mineral salt is between approximately 0.1% and 20% by weight.

12. The composition of claim 1 further comprising a resin.

13. The composition of claim 12 wherein a concentration of said resin is between approximately 0.5% and 20% by weight.

14. The composition of claim 13 wherein a concentration of said resin is between approximately 1% and 10% by weight.

15. The composition of claim 12 wherein said resin demulsifies in the composition sufficiently for the composition to comprise a heterogeneous two phase mixture.

16. A method for changing the color of a primed or unprimed non-wood substrate, the method consisting essentially of:
applying the composition of claim 1 to a primed or unprimed non-wood substrate; and
subsequently coating the colored substrate with a protective coat.

17. The method of claim 16 wherein the composition was previously created by hydrating dry and/or concentrated ingredients.

18. The method of claim 16 wherein the applying step consists essentially of spraying.

19. The method of claim 16 resulting in a simulated woodgrain colored pattern on a textured non-wood substrate.

20. A method for changing the color of a primed or unprimed non-wood substrate, the method consisting essentially of:
applying a gall ink to the substrate;
applying the composition of claim 1 to the substrate; and
subsequently coating the colored substrate with a protective coat.

21. The method of claim 20 wherein a ratio of an amount of metal salt to an amount of tannin or tannic acid in the gall ink is approximately 1:5.

22. The method of claim 21 wherein a ratio of an amount of metal salt to an amount of tannin or tannic acid in the gall ink is approximately 1:1.3.

23. The method of claim 20 wherein either or both of the applying steps consists essentially of spraying.

24. The method of claim 20 resulting in a simulated woodgrain colored pattern on a textured non-wood substrate.

25. A kit comprising:
a first container containing a first concentrate comprising a pigment and/or dye; and
a second container containing dry or concentrated mineral salts;
wherein adding a specified amount of water to a mixture of contents of said containers produces a specified amount of the composition of claim 1.

26. The kit of claim 25 further comprising a container containing a second concentrate comprising a resin and/or a container containing dry or concentrated gall ink components.

27. The kit of claim 26 wherein said second concentrate further comprises one or more substances selected from the group consisting of pigment, water, amino acid, surfactant, and emulsifying agent.

28. The kit of claim 25 wherein replacing only said second container with a different container enables said composition to be applied on a different substrate, applied with a different application method, and/or to produce a different effect, said second container containing first mineral salts and said different container containing second mineral salts.
